(19) United States
(12) Patent Application Publication
(10) Pub. No.: US 2006/0055771 A1
(43) Pub. Date: Mar. 16, 2006

(54) System and method for optimizing audio and video data transmission in a wireless system

(76) Inventor: Jonathan K. Kies, Encinitas, CA (US)

Correspondence Address: QUALCOMM, INC, 5775 MOREHOUSE DR., SAN DIEGO, CA, 92121, US

(21) Appl. No.: 10/924,687

(22) Filed: Aug. 24, 2004

(51) Int. Cl. H04N 7/14

(52) U.S. Cl. 348/14.03; 348/14.02

(57) ABSTRACT

A system and method for transmitting video and audio information among communicating wireless devices during a video conference in a wireless communications system. The audio information from all participants is received by a server, which selects a speaker among the participants. The speaker's audio and video data are transmitted to all participants according to a predefined criteria.

### BACKGROUND OF THE INVENTION

1. Field of the Invention

The present invention generally relates to wireless telecommunications, and more specifically, relates to a system and method for optimizing video and audio data transmission during a video/audio conference in a wireless network.

2. Description of the Related Art

Technology advancement has made mobile telephones or wireless communications devices cheap and affordable to almost everyone. As the wireless telephones are manufactured with greater processing ability and storage, they also become more versatile and incorporate many features including the ability to support real time video and audio conferencing. A wireless telephone can be equipped with a resident video camera and display image from the camera to other devices on the wireless network. During a video conference, a user may see images of participants, and, at the same time, listen to audio from the same participants.

During a video conference, the speaker's audio and video data are transmitted from the speaker's wireless device to a server, and then from the server to all participating wireless telephones. The video and audio data from listeners (non-speakers) may also be transmitted from their respective wireless devices to the server and then transmitted to the participants. However, because of bandwidth limitations, the stream of media between all the devices is difficult to maintain, and the resulting quality of video is often poor and the audio is often interrupted.

### SUMMARY OF THE INVENTION

The bandwidth in a wireless communication network is limited by the technology and the environment through which radio signals have to travel. The system and method according to the invention optimizes transmission of video and audio information during a video conference in the wireless network. During a video conference, the speaker's video and audio data are received from the speaker and transmitted to all non-speakers (listeners). The speaker's audio and video data are transmitted according to a predefined criterion. For example, the audio data is given a higher priority compared with the video data. The listeners' audio data are received at the server and used to determine whether to assign a new speaker. In this manner, the available resources are utilized to ensure the more critical speaker's data is maintained in the conference. The new speaker may also be determined through a priority list, where each member is pre-assigned a priority.

In one embodiment, the invention is a method for transmitting audio and video information from a server to a plurality of wireless devices during a video conference through a wireless telecommunication network. The method comprises the steps of receiving at the server a plurality of videos from the plurality of the wireless devices, receiving at the server a plurality of audio data from the plurality of the wireless devices, selecting a speaker from the plurality of the wireless device, and transmitting the video and the audio data of the speaker to the plurality of the wireless devices except the wireless device of the speaker. Each audio and video data are associated with a wireless device and each audio data is also associated with a volume. The audio and video data of the speaker are transmitted according to a predefined criteria.

In another embodiment, the invention further includes a method for transmitting and receiving video and audio information at a wireless device during a video conference, wherein the wireless device having an audio device and a display device. The method comprising the steps of, if the wireless device is assigned as a speaker, transmitting video and audio information to a remote server, and if the wireless device is not assigned as the speaker, transmitting audio information to the remote server. The method further includes the steps of receiving the speaker's video and audio information from the remote server, playing the audio information received from the remote server on the audio device, and displaying the video information received from the remote server on the display device.

In another embodiment, the system for transmitting and displaying video and audio information during a video conferencing session in a wireless communication network includes a server in communication with the wireless communication network, wherein the server including a video and audio transmission criteria, and a plurality of wireless communication devices capable of communicating with the server through the wireless communication network, wherein each wireless communication device capable of transmitting and receiving the audio and video information to the server according to the video and audio data transmission criteria.

The system also includes an apparatus for enabling transmission and playing video and audio information on a wireless telecommunication device in wireless communication network. The apparatus includes a transceiver for transmitting and receiving audio and video information from a remote server, a storage unit for storing the audio and video information, a display unit for displaying the video information to a user, a speaker unit for playing the video information to the user, a user interface unit for receiving the audio information from the user, a push-to-talk interface for receiving a floor request from the user, and a controller for controlling the display unit based on a speaker information received from the remote server.

The present system and methods are therefore advantageous as they optimize transmission of video and audio information during a video conference in a wireless communications network.

Other advantages and features of the present invention will become apparent after review of the hereinafter set forth Brief Description of the Drawings, Detailed Description of the Invention, and the Claims.

### BRIEF DESCRIPTION OF THE DRAWINGS

FIG. 1 is a wireless network architecture that supports video conferencing in a wireless system.

FIG. 2 is a block diagram of a wireless device that supports the transmission of alert tone information in a push-to-talk system.

FIG. 3 is a diagram representing interactions between a server and remote wireless devices during a video conferencing.

FIG. 4 is an illustration of a wireless device displaying a video of a speaker during a video conferencing.

FIG. 5 is a flow chart for a server process that distributes video and audio information.

FIG. 6 is a flow chart for a device process for receiving and transmitting audio and video information.

FIGS. 7A and 7B are examples of video/audio transmission criteria.

FIG. 8 is a flow chart for a server process according to an alternative embodiment.

FIG. 9 is a flow chart for a server process according to yet another alternative embodiment.

### DETAILED DESCRIPTION OF THE INVENTION

In this description, the terms “communication device,” “wireless device,” “wireless communications device,” “wireless handset,” “handheld device,” and “handset” are used interchangeably, and the term “application” as used herein is intended to encompass executable and nonexecutable software files, raw data, aggregated data, patches, and other code segments. Further, like numerals refer to like elements throughout the several views, and the articles “a” and “the” includes plural references, unless otherwise specified in the description.

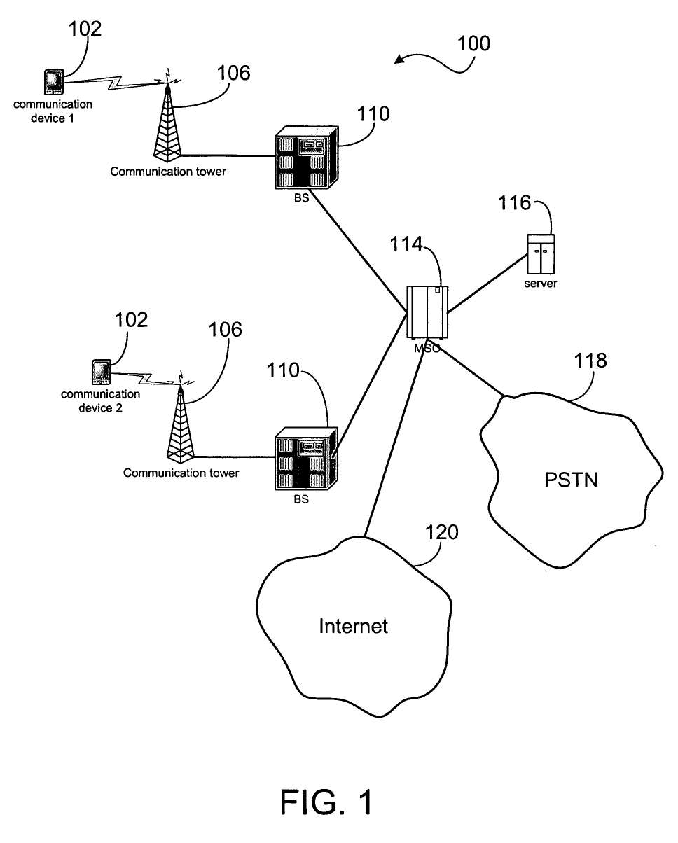

FIG. 1 depicts a communication network 100 used according to the present invention. The communication network 100 includes one or more communication towers 106, each connected to a base station (BS) 110 and serving users with communication device 102. The communication device 102 can be cellular telephones, pagers, personal digital assistants (PDAs), laptop computers, or other hand-held, stationary, or portable communication devices that supports push-to-talk (PTT) communications. The commands and data input by each user are transmitted as digital data to a communication tower 106. The communication between a user using a communication device 102 and the communication tower 106 can be based on different technologies, such code division multiplexed access (CDMA), time division multiplexed access (TDMA), frequency division multiplexed access (FDMA), the global system for mobile communications (GSM), or other protocols that may be used in a wireless communications network or a data communications network. The data from each user is sent from the communication tower 106 to a base station (BS) 110, and forwarded to a mobile switching center (MSC) 114, which may be connected to a public switched telephone network (PSTN) 118 and the Internet 120. The MSC 114 may be connected to a server 116 that supports the video conferencing feature in the communications network 100. The server 116 includes an application that supports the video conferencing feature besides storing a predefined criterion that assigns different priority to video and audio data transmission. Optionally, the server 116 may be part of the MSC 114.

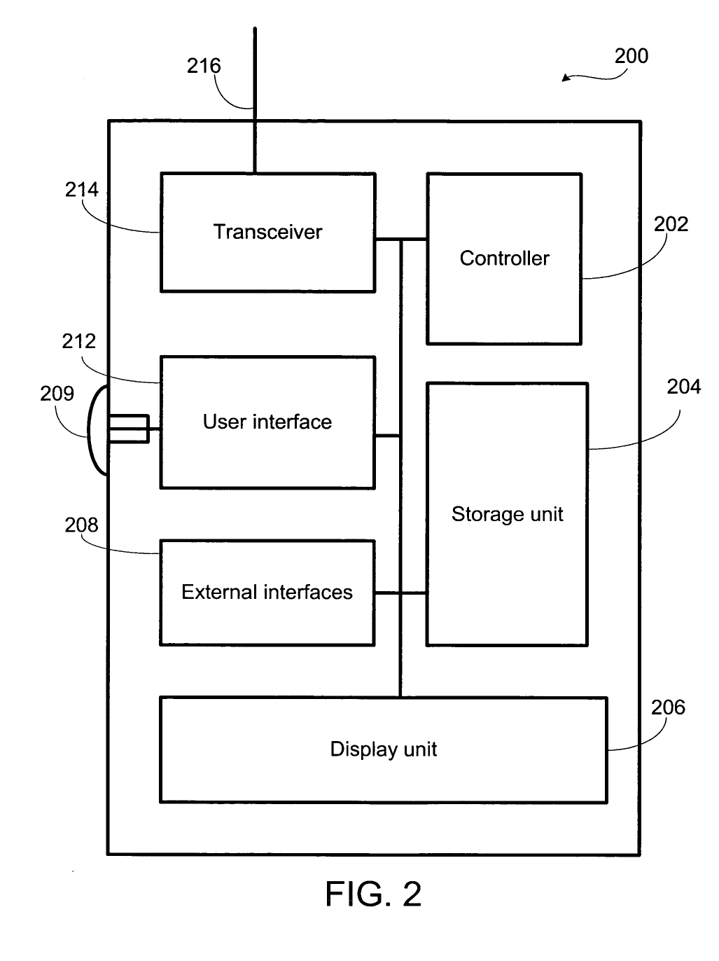

FIG. 2 illustrates a block diagram 200 of a wireless handset 102. The wireless handset 102 includes a controller 202, a storage unit 204, a display unit 206, an external interface unit 208, a user interface unit 212, a push-to-talk activation unit 209, a transceiver 214, and an antenna 216. The controller 202 can be hardware, software, or a combination thereof. The display unit 206 may display graphical images or other digital information to the user. The external interface unit 208 controls hardware, such as speaker, microphone, and display unit, used for communication with the user. The user interface unit 212 controls hardware, such as keypad and push-to-talk activation unit 209. The push-to-talk activation unit 209 may be used during a video conference to make a floor request, i.e., to request a speaking opportunity during when another user is speaking. The transceiver 214 transmits and receives radio signals to and from a communication tower 106. The controller 202 interprets commands and data received from the user and the communication network 100.

During a video conference and when a user does not have the floor, i.e., the user is not the current speaker, the wireless device 102 receives the speaker's audio and video information from a remote server and displays video data on a screen and audio data on a phone (speaker) device. If the user wants to speak, he may push the push-to-talk button 209, if the wireless device is equipped with the PTT button. Alternatively, he may speak in a louder voice, and this increase in volume would be interpreted by the remote server as a request to become the speaker. If the user is not the speaker, his video information is not transmitted to the remote server, thereby saving bandwidth. Generally, the audio information is considered more important than video information during a video conference, therefore, the wireless device 102 may request retransmission of loss audio packets but not loss video packets from the remote server.

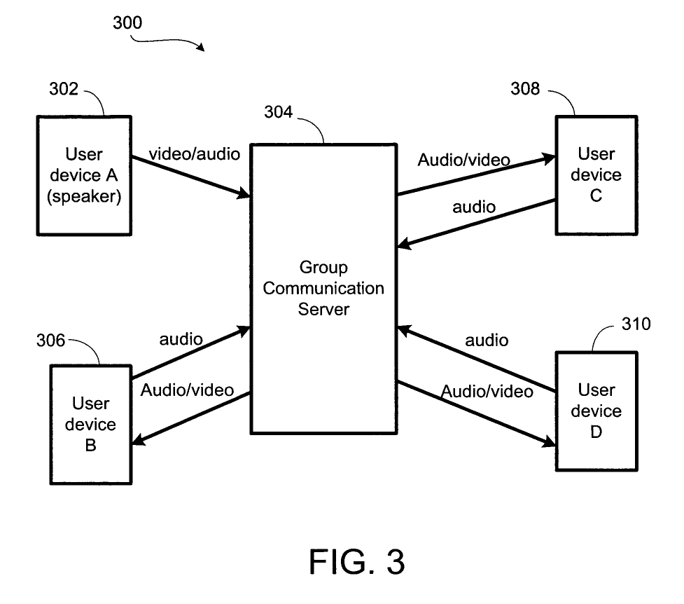

FIG. 3 is a diagram 300 representing interactions between the server (also known as group communication server) and user devices during a video conference. During a video conference a user is assigned as the speaker and the user has the “floor.” The video and audio data from the speaker 302 are transmitted to the server 304 and the server 304 broadcasts the speaker's video and audio data to all non-speakers in the video conference. When broadcasting the video and audio data, the server 304 may assign higher priority to audio transmission and a lower priority to video transmission. The audio transmission may have a higher bandwidth than the video transmission. This preferred criterion results in a better audio quality. The server 304 may also assign, for example when transmitting video and audio data to non-speakers, 60% of bandwidth to audio data and 40% of bandwidth to video data. The images from the non-speakers are not transmitted to the server 304 so the bandwidth can be saved. Though the audio data from the non-speakers are not transmitted from the server 304 to every participating user, non-speakers' audio data are transmitted to the server 304. The non-speakers' audio data may be used to determine the next speaker.

A new speaker in a video conference may be determined by several ways. One way to select a new speaker is to compare the volume of audio received from all participants. The participant with the highest audio volume will be assigned as the new speaker. Another way to select a new speaker is to wait for a “floor” request from a user. A user may request the floor by using the PTT button and if the current speaker is idle for a predefined period, the requesting user will be assigned as the new speaker.

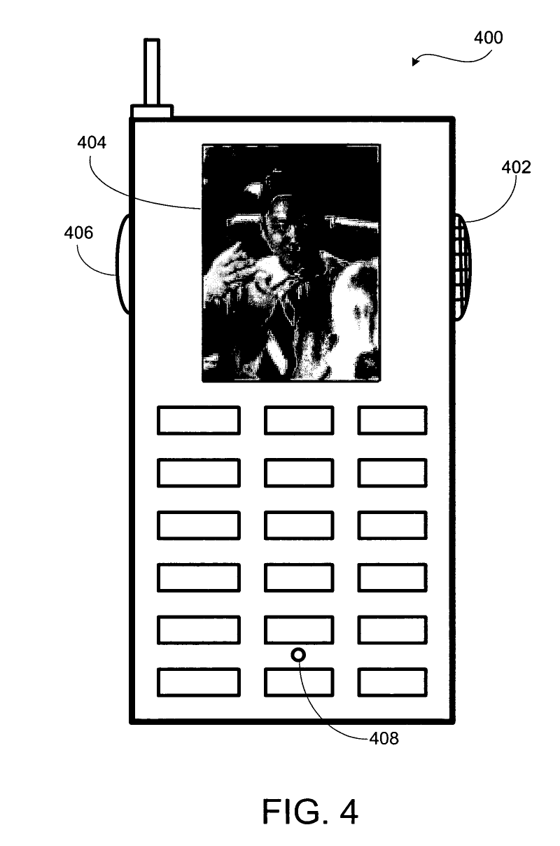

FIG. 4 illustrates a wireless communication device 400 displaying a video image on a display screen 404 and audio message on a speaker 402. A user may request the floor by activating a push-to-talk button 406 or by speaking in a louder voice into a microphone 408.

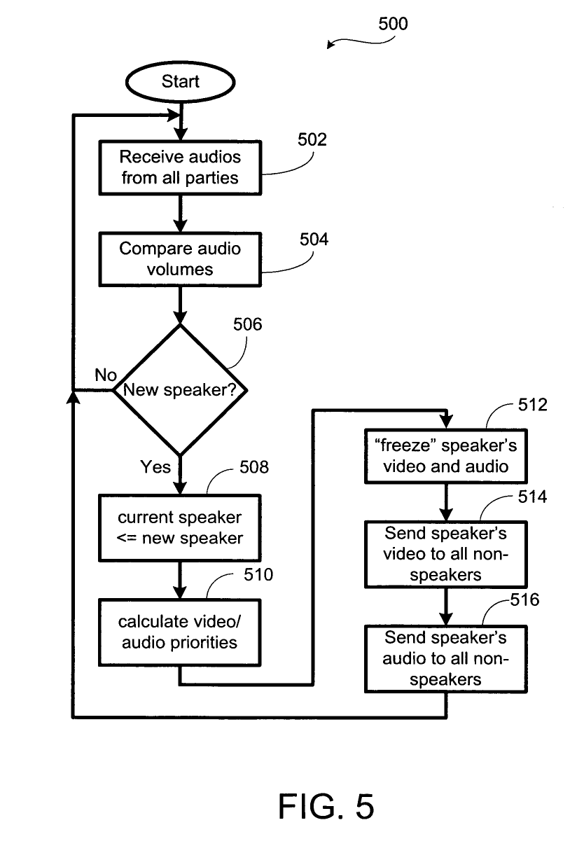

FIG. 5 is a flow chart for a server process 500. During a video conference with many participants, the server 116 receives audio data from all parties, step 502, and compares their volume, step 504. A participant with a louder voice will be assigned as the new speaker. The server 116 checks whether the new speaker is the same as the previous speaker, step 506. If there is a new speaker, the identity of the new speaker is stored in the server 116, step 508. The server 116 calculates the video and audio priorities, step 510, for the audio and video data transmission. The video and audio priorities may be the same as the ones set up for the previous speaker or may be a new set of priorities. The server 116 proceeds to “freeze” the video and audio data transmission to the new speaker, step 512. When the server 116 stops to transmit the video information to the speaker's wireless handset 102, the server 116 may send a special command instructing the speaker's wireless handset 102 to “freeze” its last displayed image. Alternatively, the server 116 may transmit a single picture of the speaker himself back to the speaker's wireless handset 102, and this picture will be displayed to the speaker and identifying himself as the current speaker. Generally, the speaker needs not to see his own image nor hear his own voice retransmitted back to him. The server 116 proceeds to send the speaker's video and audio information to all non-speakers, steps 514 and 516. The server 116 continues to monitor the video conference until it ends (not shown).

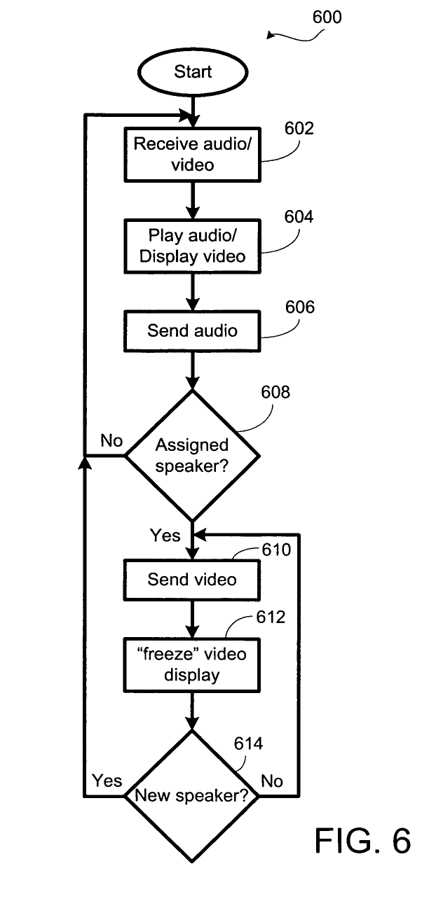

FIG. 6 is a flow chart for a device process 600. A wireless device 102 receives a speaker's audio and video information from the server 116 during a video conference, step 602, and plays audio and video data on the wireless device 102, step 604. Because the wireless device 102 is not the current speaker, it only sends user's audio data to the server 116, step 606, and does not send any video to the server 116. The user may request the floor during the video conference by raising his voice or by activating a PTT button. The user's audio data and a signal relating to the activation of the PTT button are sent to the server 116, where the decision to assign a new speaker is made. The server 116 sends a signal or message information the wireless device 102 informing that it is the current speaking device. The wireless device 102 checks for incoming messages to see if it is assigned as the new speaker, step 608. If the wireless device 102 is assigned as the new speaker, it starts to send the user's video to the server 116, step 610, and freezes the video display, step 612. The wireless device 102 continuously checks whether a different new speaker has been assigned, step 614.

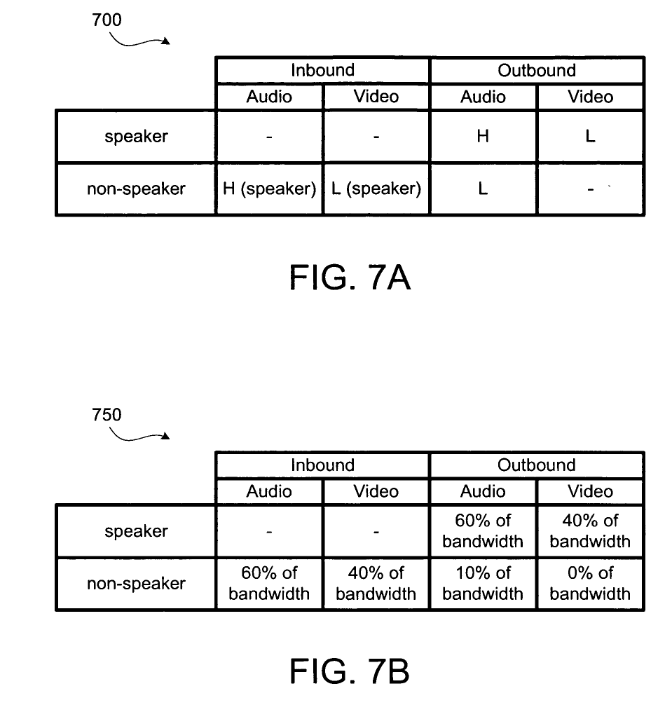

FIG. 7A is one embodiment of audio and video data transmission criteria. For a wireless device assigned as the speaker, no inbound video and audio data are handled and outbound audio data is given a higher priority while the outbound video is given a lower priority. When a wireless device is not assigned as the speaker, its outbound video data is disabled and outbound audio data is transmitted with low priority. Its inbound audio data arrives with a higher priority than its inbound video. Another way for handling audio and video data may be assigning them different bandwidth and FIG. 7B illustrates one example of this audio and video data transmission criteria. A preference may be given to the audio data transmission since more information may be transmitted through audio data during a video conference. Although in FIG. 7B audio data is given 60% of bandwidth and video data is given 40% of bandwidth, other distributions are possible. In the same example, when a wireless device is not the current speaker, its outbound video is disabled (0%) and its outbound is given a low 10% bandwidth.

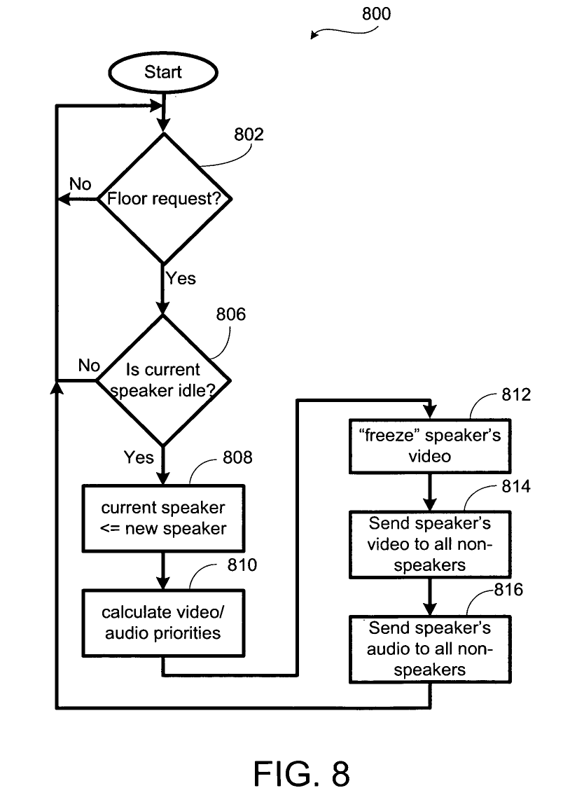

FIG. 8 is an alternative server process 800 when a signal is used to indicate a floor request. The floor request signal may be transmitted from a wireless device after a user pushes a PTT button during a video conference. The server 116 checks whether a floor request is received from any of the wireless devices 102, step 802. If a floor request is received, the server 116 checks whether the current speaker is “idle,” step 806. The current speaker may be idle if there is no audio information coming from the speaker's wireless device for a predefined period, for example two seconds. The server 116 may adjust this idle period. If the current speaker is idle, the server 116 sets the requesting wireless device as the current speaker, step 808, and proceeds to calculate video and audio priorities and sends out audio and video information as previously described in FIG. 5.

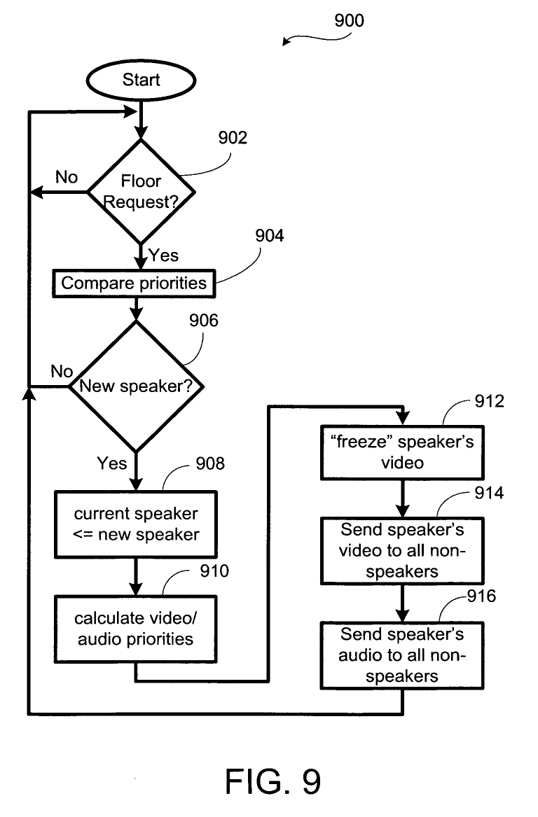

FIG. 9 is yet another alternative server process 900 when each wireless device is assigned a priority. The priority may be assigned by the server 116 or by the party who set up the video conference. The host of the video conference may be given by default the highest priority. The server 116 checks whether a floor request is received from any of the wireless devices 102, step 902. If a floor request is received, the server 116 compares the priority of the requesting wireless device against the priority of the current speaker, step 904. If the requesting wireless device has a higher priority, then the server 116 assigns it as the new speaker. If the requesting wireless device has a lower priority, then the server 116 may wait until the speaker is idle before assigning the requesting wireless device as the new speaker. When there is a new speaker, the server 116 sets the requesting wireless device as the current speaker, step 908, and proceeds to calculate video and audio priorities and sends out audio and video information as previously described in FIG. 5.

The following is a description of one use scenario according to one embodiment of the invention. When a user wants to have a video conference with two associates, the user may set up the video conference request using his computer. He enters his wireless device information as the host. A second participant may use a second wireless device, and a third participant may use a wireline based video telephone. The user may assign the highest priority to himself and next priority to the second participant and the lowest priority to the wireline based participant. The user may make assignment by using either his wireless device or through his computer prior to the video conference. During the video conference, when the user has the floor, the server sends the user's video and audio data to the second and third participants. The video data is sent with a lower priority than the audio data.

While the user has the floor, the second participant presses a PTT button to request the floor so he can add a comment. The wireless device of the second participant sends a request to the server. The server receives the request and checks the second participant's priority. Because the second participant has a lower priority than the current speaker, the server does not interrupt the current speaker. Instead, the server waits until the current speaker is idle and then assigns the second participant as the new speaker. When the second participant becomes the speaker, he may want to share a picture with other two participants. He may direct his wireless handset to send a picture stored in his wireless handset instead of his image to the server. The server will send the picture to other participants along with the audio data from the second participant. If the second participant wants to share information with other two participants, he pushes the PTT button and a floor request is sent from his wireless device to the server.

In view of the method being executable on a wireless service provider's computer device or a wireless communications device, the method can be performed by a program resident in a computer readable medium, where the program directs a server or other computer device having a computer platform to perform the steps of the method. The computer readable medium can be the memory of the server, or can be in a connective database. Further, the computer readable medium can be in a secondary storage media that is loadable onto a wireless communications device computer platform, such as a magnetic disk or tape, optical disk, hard disk, flash memory, or other storage media as is known in the art.

In the context of FIGS. 5-9, the method may be implemented, for example, by operating portion(s) of the wireless network, such as a wireless communications device or the server, to execute a sequence of machine-readable instructions. The instructions can reside in various types of signal-bearing or data storage primary, secondary, or tertiary media. The media may comprise, for example, RAM (not shown) accessible by, or residing within, the components of the wireless network. Whether contained in RAM, a diskette, or other secondary storage media, the instructions may be stored on a variety of machine-readable data storage media, such as DASD storage (e.g., a conventional “hard drive” or a RAID array), magnetic tape, electronic read-only memory (e.g., ROM, EPROM, or EEPROM), flash memory cards, an optical storage device (e.g. CD-ROM, WORM, DVD, digital optical tape), paper “punch”cards, or other suitable data storage media including digital and analog transmission media.

While the invention has been particularly shown and described with reference to a preferred embodiment thereof, it will be understood by those skilled in the art that various changes in form and detail may be made without departing from the spirit and scope of the present invention as set forth in the following claims. Furthermore, although elements of the invention may be described or claimed in the singular, the plural is contemplated unless limitation to the singular is explicitly stated.

What is claimed is:

1. A method for transmitting a speaker's wireless device audio and video information from a server to a plurality of wireless devices during a video conference over a wireless telecommunication network, comprising the steps of:
receiving at the server a plurality of video data from the plurality of the wireless devices, each video data associated with a wireless device;
receiving at the server a plurality of audio data from the plurality of the wireless devices, each audio data having a volume level and associated with a wireless device;
selecting a speaker from the plurality of wireless devices; and
transmitting the video and the audio data of the speaker to the plurality of the wireless devices except to the wireless device of the speaker, wherein the video data and the audio data of the speaker are transmitted based upon a predefined criteria, wherein the speaker's video and audio data has a priority over non-speakers' audio and video data.

2. The method of claim 1, wherein the step of selecting a speaker further comprising the steps of:
comparing volume levels of the plurality of the audio data received;
selecting an audio data with a highest volume level; and
assigning as the speaker the wireless device associated with the selected audio data.

3. The method of claim 1, wherein the step of selecting a speaker further comprising the steps of:
receiving a speaking request from one of the wireless devices; and
assigning as the speaker the wireless device associated with the speaking request.

4. The method of claim 3, wherein the step of assigning the speaker further comprising the step of, if the audio data from the speaker is silent for a predefined period, assigning as the speaker the wireless device associated with the speaking request.

5. The method of claim 1, wherein the step of selecting a speaker further comprising the steps of:
receiving a speaking request from a requesting wireless device;
obtaining a priority associated with the requesting wireless device;
comparing the priority of the requesting wireless device with a priority of a current wireless device; and
if the priority of the requesting wireless device is higher than the priority of the current wireless device, assigning as the speaker the requesting wireless device.

6. The method of claim 1, wherein the criteria further comprising transmitting the audio data with a high priority and transmitting the video data with a low priority.

7. A method for transmitting and receiving video and audio information at a wireless device during a video conference, the wireless device having an audio device and a display device, comprising the steps of:
if the wireless device is assigned as a speaker, transmitting video and audio information to a remote server;
if the wireless device is not assigned as the speaker,
transmitting audio information to the remote server, and
receiving the speaker's video and audio information from the remote server;
playing the audio information received from the remote server on the audio device; and
displaying the video information received from the remote server on the display device.

8. The method of claim 7, further comprising the steps of:
receiving a floor request from a wireless device; and
transmitting the floor request to the remote server.

9. The method of claim 7, further comprising the step of receiving a speaker assignment from the remote device.

10. The method of claim 7, wherein the step of displaying the video information further comprising the step of, if the wireless device is assigned as the speaker, freezing the video information.

11. An apparatus for enabling transmission and playing video and audio information on a wireless telecommunication device in wireless communication network, comprising:
a transceiver for transmitting and receiving audio and video information from a remote server;
a storage unit for storing the audio and video information;
a display unit for displaying the video information;
a speaker unit for playing the video information;
an interface unit for receiving audio information;
a push-to-talk interface for receiving a floor request during a video conference; and
a controller for controlling the display unit based on speaker information received from the remote server.

12. An apparatus for enabling transmission and playing video and audio information on a wireless telecommunication device in wireless communication network, comprising:
means for transmitting and receiving audio and video information from a remote server;
means for storing the audio and video information;
means for displaying the video information;
means for playing the video information;
means for receiving audio information;
means for receiving a floor request during a video conference; and
means for controlling the means for displaying the video information based on a speaker information received from the remote server.

13. A computer-readable medium on which is stored a computer program for transmitting a speaker's wireless device audio and video information from a server to a plurality of wireless devices during a video conference over a wireless telecommunication network, the computer program comprising computer instructions that when executed by a computer performs the steps of:
receiving at the server a plurality of video data from the plurality of the wireless devices, each video data associated with a wireless device;
receiving at the server a plurality of audio data from the plurality of the wireless devices, each audio data having a volume level and associated with a wireless device;
selecting a speaker from the plurality of wireless devices; and
transmitting the video and the audio data of the speaker to the plurality of the wireless devices except to the wireless device of the speaker,
wherein the video data and the audio data of the speaker are transmitted based upon a predefined criteria, wherein the speaker's video and audio data has a priority over non-speakers' audio and video data.

14. The computer program of claim 13, wherein the step of selecting a speaker further comprising the steps of:
comparing volume levels of the plurality of the audio data received;
selecting an audio data with a highest volume level; and
assigning as the speaker the wireless device associated with the selected audio data.

15. The computer program of claim 13, wherein the step of selecting a speaker further comprising the steps of:
receiving a speaking request from one of the wireless devices; and
assigning as the speaker the wireless device associated with the speaking request.

16. The computer program of claim 15, wherein the step of assigning the speaker further comprising the step of, if the audio data from the speaker is inactive for a predefined period, assigning as the speaker the wireless device associated with the speaking request.

17. The computer program of claim 13, wherein the step of selecting a speaker further comprising the steps of:
receiving a speaking request from a requesting wireless device;
obtaining a priority associated with the requesting wireless device;
comparing the priority of the requesting wireless device with a priority of a current wireless device; and
if the priority of the requesting wireless device is higher than the priority of the current wireless device, assigning as the speaker the requesting wireless device.

18. The computer program of claim 13, wherein the criteria further comprising transmitting the audio data with a high priority and transmitting the video data with a low priority.

19. A computer-readable medium on which is stored a computer program for transmitting and receiving video and audio information at a wireless device during a video conference, the wireless device having an audio device and a display device, the computer program comprising computer instructions that when executed by a computer performs the steps of:
if the wireless device is assigned as a speaker, transmitting video and audio information to a remote server;
if the wireless device is not assigned as the speaker,
transmitting audio information to the remote server, and
receiving the speaker's video and audio information from the remote server;
playing the audio information received from the remote server on the audio device; and
displaying the video information received from the remote server on the display device.

20. The computer program of claim 19, further comprising the steps of:
receiving a floor request; and
transmitting the floor request to the remote server.

21. The computer program of claim 19, further comprising the step of receiving a speaker assignment from the remote device.

22. The computer program of claim 19, wherein the step of displaying the video information further comprising the step of, if the wireless device is assigned as the speaker, freezing the video information.

23. A system for transmitting and displaying priority video and audio information at a plurality of wireless devices engaging in a video conferencing session in a wireless communication network, comprising:
a server in communication with the wireless communication network, the server including a video and audio data transmission priority criteria, wherein the wireless device of a current speaker is given a high priority; and
a plurality of wireless communication devices capable of communicating with the server through the wireless communication network, each wireless communication device capable of transmitting and receiving the audio and video information to the server according to the video and audio data transmission criteria.

24. The system of claim 23, wherein the server further includes a predefined priority table with a plurality of entries, wherein each entry is assigned to a wireless communication device.

25. The system of claim 24, wherein the server assigns a wireless communication device as a current speaker based on the predefined priority table.

26. The system of claim 24, wherein the video and audio transmission criteria assign a high priority to audio information and a low priority to video information from a wireless communication device assigned as a current speaker.

27. The system of claim 23, wherein the server receives audio from the plurality of wireless communication devices and assigns a wireless communication device as a current speaker.

28. The system of claim 27, wherein the server assigns a wireless communication device as a current speaker based on a volume associated with the audio information.
